(19) United States
(12) Patent Application Publication
(10) Pub. No.: US 2008/0239877 A1
(43) Pub. Date: Oct. 2, 2008

(54) METHOD AND APPARATUS FOR FOCUSED DETECTION OF HAZARDOUS ATMOSPHERIC CONDITIONS

(75) Inventor: Frank L. Rees, Baltimore, MD (US)

Correspondence Address: TOBIN, CARBERRY, O'MALLEY, RILEY, SELINGER, P.C., 43 BROAD STREET, PO BOX 58, NEW LONDON, CT, 06320, US

(73) Assignee: Flight Safety Technologies, Inc, Mystic, CT (US)

(21) Appl. No.: 11/400,338

(22) Filed: Apr. 6, 2006

(51) Int. Cl. G01H 9/00

(52) U.S. Cl. 367/149; 73/656

(57) ABSTRACT

A method of detecting hazardous conditions to aircraft is disclosed. The hazardous conditions produce sound waves in the atmosphere. The method comprises directing a first laser beam from a first laser acoustic sensor to a mating first reflector; directing a second laser beam from a second laser acoustic sensor to a mating second reflector; and directing a third laser beam from a third laser acoustic sensor to a mating third reflector. The method further comprises aligning the first laser acoustic sensor to project a first beam pattern, the second laser acoustic sensor to project a second beam pattern, and the third laser acoustic sensor to project a third beam pattern. The method further comprises measuring an effect of the sound waves on the first beam pattern, the second beam pattern, and the third beam pattern. The effect is an indicator of the hazardous conditions.

### BACKGROUND

The present invention relates generally to a sensing system for detecting adverse weather conditions and other atmospheric disturbances that are hazardous to flying aircraft, and more particularly, it relates to a system that can be focused to detect these hazardous conditions.

Since about the 1970's, it has been recognized that atmospheric phenomena contain (or generate) acoustic patterns (or signatures) in the form of very low frequency sound waves which travel over long distances relatively unimpeded by the surrounding weather or other atmospheric phenomena. This sound generation phenomena, known as ring-eddy vortexing and its associated velocity circulation and unsteady flow fields, essentially create radiated sound which resembles the wave patterns occurring in a body of water after a pebble has been tossed into it. The rings created by the pebble intrusion are similar in shape to the acoustic patterns associated with severe thunderstorms, wake vortices and other clear air turbulence.

It has also been publicly known since about the 1970's that moving objects, such as ships, submarines or animals, in water generate and radiate sound waves which may be detected by a laser sensing system utilizing free space or wave guided light beams to indicate the presence and location of those sound radiating or reflecting objects in the water. One such system is illustrated in U.S. Pat. No. 5,504,719 to Jacobs.

U.S. Pat. No. 5,504,719 to Jacobs utilizes a pair of adjustable mirrors between which radar waves are reflected. Reflecting of light or other radiation is known in the art. Retro-reflectors have been utilized since the early 1950s and used in various endeavors including NASA missions to the moon. Eaton lenses have a concentrically graded refractive-index prescription as a function of the radial position from the center of the sphere to the outer radius of this spherical-type lens. Unlike related Luneburg spherical lenses, this lens has a different prescription. This prescription serves to take the rays associated with points on an incoming wave-front in such a way as to bend the rays occupying one side of the incident-wave axis in circular paths with radii corresponding to their offset position relative to this center axis. As a consequence, these rays coherently re-emerge to re-constitute half of the original wave-front, but now propagating in a direction that is directly returned towards their original source; while the counterpart rays on the other side of this center axis also behave in this reversed-image, self-returned manner.

A laser detection system responsive to sound waves produced by adverse and hazardous weather or wake-vortex conditions to provide an advance warning of those conditions to aircraft pilots or airport ground personnel is illustrated in U.S. Pat. No. 6,034,760 to Rees (the '760 patent). The '760 patent discloses a method and apparatus for detecting conditions in the atmosphere which are hazardous to flying aircraft and providing early warning to pilots or ground personnel. The method includes using a laser beam and a coherent optical receiver to optically sense sound waves produced by those hazardous conditions and measuring the effect of those sound waves on the transmitted and received optical beams.

The '760 patent described a method and apparatus entitled segmented optical line array using retro-reflectors (SOLAR) that consisted of a set of parallel overlapping laser beams, each optically sensing sound. The SOLAR system was intended to provide the capability to localize remote atmospheric hazards. While the '760 patent provided a system to remotely detect conditions in the atmosphere which are hazardous to flying aircraft and provide early warning to pilots or ground personnel, the disclosed configuration of the sensing system is not appropriate at all airport locations. For example, many coastal airports have runways that are disposed in the waterway (i.e., a pier) in order to acquire more landing/takeoff space. The lack of space due to the presence of, for example, waterways, existing structures, or other reserved uses for land, cause the detection system to be either inoperative or costly.

What is needed in the art is a system to detect, via acoustic sensing, conditions in the atmosphere that are hazardous to aircraft that approach or depart from airport runways. Furthermore, this system must be capable of stand-off acoustic sensing and it must be able to track wake vortices in three-dimensions.

### SUMMARY

The following presents a simplified summary of the present invention in order to provide a basic understanding of some aspects of the present invention. This summary is not an extensive overview of the present invention. It is not intended to identify key or critical elements of the present invention or to delineate the scope of the present invention. Its sole purpose is to present some concepts of the present invention in a simplified form as a prelude to the more detailed description that is presented herein.

The disclosure is directed toward a method of detecting hazardous conditions to aircraft. The hazardous conditions produce sound waves in the atmosphere. The method comprises directing a first laser beam from a first laser acoustic sensor to a mating first reflector; directing a second laser beam from a second laser acoustic sensor to a mating second reflector; and directing a third laser beam from a third laser acoustic sensor to a mating third reflector. The method further comprises aligning the first laser acoustic sensor, the second laser acoustic sensor, and the third laser acoustic sensor to project a first beam pattern, a second beam pattern, and a third beam pattern. The method further comprises measuring an effect of the sound waves on the first beam pattern, the second beam pattern, and the third beam pattern. The effect is an indicator of the hazardous conditions.

The disclosure is directed to an apparatus for detecting hazardous conditions to aircraft. The hazardous conditions produce sound waves in the atmosphere. The apparatus comprises a first laser acoustic sensor configured to project a first laser beam to a mating first reflector; a second laser acoustic sensor configured to project a second laser beam to a mating second reflector; a third laser acoustic sensor configured to project a third laser beam to a mating third reflector; a first beam pattern projected from the first laser acoustic sensor; a second beam pattern projected from the second laser acoustic sensor; a third beam pattern projected from the third laser acoustic sensor; and a means for measuring an effect of the sound waves on the first beam pattern, the second beam pattern, and the third beam pattern. The effect is an indicator of the hazardous conditions.

### BRIEF DESCRIPTION OF THE FIGURES

Referring now to the figures, wherein like elements are numbered alike:

FIG. 1 is a prior art sensing system;

FIG. 2 is a perspective view of an exemplary embodiment of an opto-acoustic sensor array;

FIG. 3 is a perspective view of an exemplary embodiment of a module, comprising a laser acoustic sensor utilized in a tower of the opto-acoustic sensor array of FIG. 2;

FIG. 4 is a perspective view of an exemplary embodiment of a module, comprising a retro-reflector utilized in a tower of the opto-acoustic sensor array of FIG. 2;

FIG. 5 is a side view of another embodiment of a tower utilized in an opto-acoustic sensor array;

FIG. 6 is a top view of another embodiment of an opto-acoustic sensor array;

FIG. 7 is a top view of another embodiment of an opto-acoustic sensor array illustrating the focusing for horizontal resolution; and

FIG. 8 is a perspective view of two opto-acoustic sensor arrays utilized in combination at an airport setting.

### DETAILED DESCRIPTION

Persons of ordinary skill in the art will realize that the following disclosure is illustrative only and not in any way limiting. Other embodiments of the invention will readily suggest themselves to such skilled persons having the benefit of this disclosure.

The following disclosure incorporates by reference herein, in its entirety, the subject matter disclosed in U.S. Pat. No. 6,034,760 to Rees. Specifically, the following disclosure incorporates by reference herein the laser detection system, the methods of detecting hazardous atmospheric conditions, and the operation of the laser detection system.

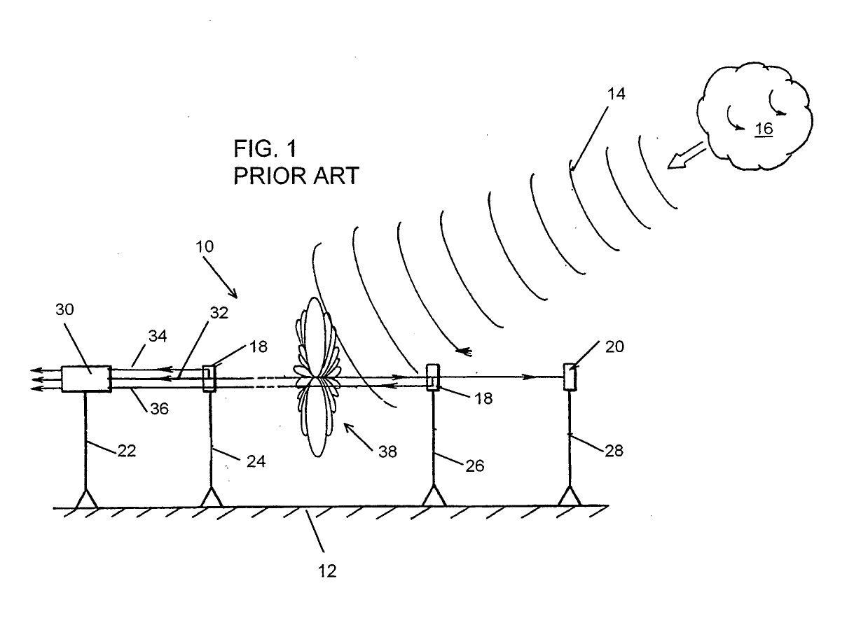

Referring now to prior art FIG. 1, a ground based system 10 extends across an airport runway 12 and utilizes refractive index (RI) coupling responsive to sound waves 14 produced by various aviation atmospheric hazards 16 (e.g., a storm cloud is illustrated). The system 10 employs a segmented optical line array using retro-reflectors (or reflectors or Eaton lens) 18, 20 and includes a plurality of adjustable leveling tables 22, 24, 26 and 28 that are spaced uniformly and in line across the runway 12.

Mounted on table 22 is a combination laser transmitter and coherent optical receiver module 30 which transmits a laser beam 32 to an aligned retro-reflector 20 mounted on table 28. On each of the intermediate tables 24, 26 are identical partially reflecting retro-reflectors 18 each of which will reflect part of beam 32 (i.e., 34 and 36) back to the transmitter-receiver 30.

The prior art ground based system 10 provides an optical line array from which acoustic multi-beam or beam steerable response patterns 38 may be formed. Such beam-formed response patterns 38 are capable of receiving and localizing distant sound sources 16 and rejecting local sonic and subsonic interference.

This prior art ground based system spans across a runway approach zone while capturing the sound interfacing with the laser. Not only does this prior art system occupy valuable runway approach zone space, but it requires the sound to come from above the system. The need to track sound waves produced by hazardous conditions at remote distances requires a more sophisticated system than the prior art ground-based planar array.

Tracking of sound waves can be accomplished by acoustic sensing. Acoustic sensing is necessary since it allows for the tracking of the wake vortices generated by aircraft even in low visibility conditions, such as fog or low hanging clouds.

The present invention provides for use of the laser detection system encompassing a series of lasers that can detect sound waves (via acoustic sensing) produced by hazardous conditions at remote distances. Several geometric configurations are contemplated, all achieving the same result; the focusing of the laser acoustic sensors to create a signal array gain and tracking capability in the region (i.e., air volume) of interest.

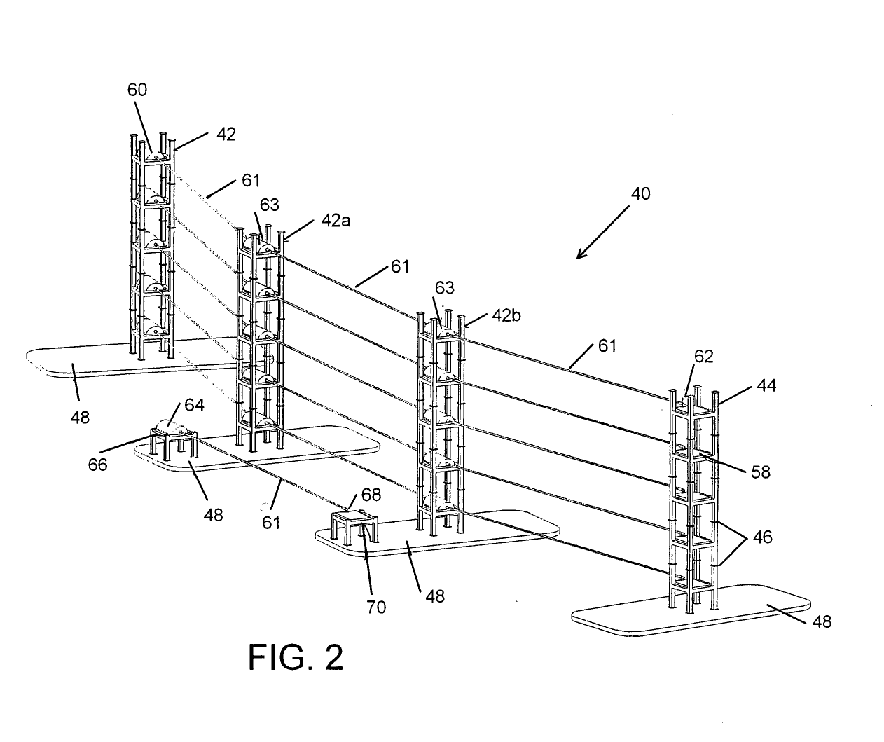

Referring to FIG. 2, an exemplary embodiment for focusing an opto-acoustic sensor array in the form of a billboard is illustrated. The billboard array 40 is comprised of a series of vibration isolation towers 42, 44 that are “canted” or positioned end-to-end around an arc. Although an end-to-end arc is illustrated, other configurations are contemplated, including split arcs, overlapping arcs, and the like, including other configurations as illustrated herein.

The height of the towers can vary depending upon the need at each individual airport. In a preferred embodiment, the height of the towers is about 10 feet to about 25 feet, with about 15 feet to about 20 feet preferred. Preferably, the distance between towers (i.e., the distance between the laser acoustic sensors and the reflectors) is in the range of about 50 meters to about 300 meters, with about 100 meters preferred. The vertical height is dependent upon the desired resolution for tracking the elevation of the atmospheric disturbance. A taller height (i.e., larger aperture) yields a finer resolution of the sound source. While a vertical tower is the preferred configuration, certain situations will call for varying angles for the billboard array. This can range from vertical through all the angles to a horizontal configuration, in order to form a focused area array.

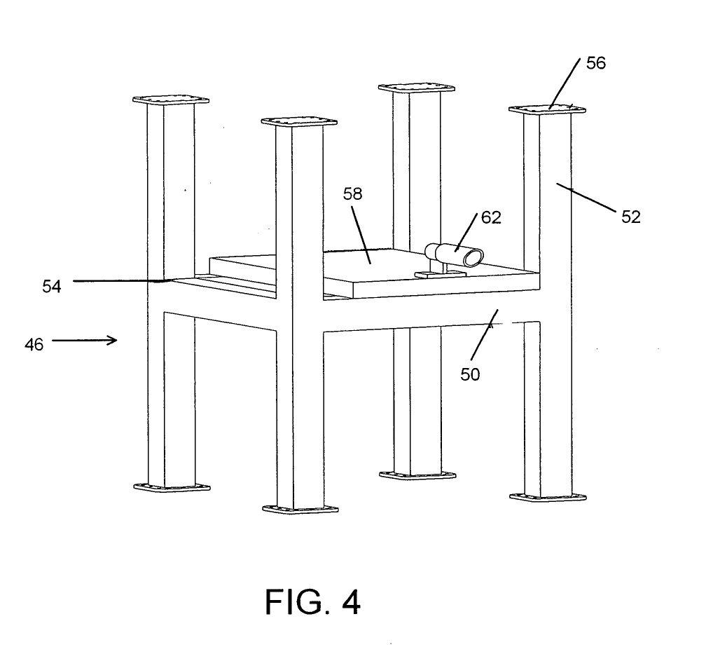

Exemplary constructions of the towers are illustrated in FIGS. 2, 3, 4, and 5. In a preferred embodiment, each tower (i.e., 42, 44) is constructed of several modules 46. For example, as illustrated in FIG. 2, five modules 46 are coupled together to form the towers 42, 44. The towers 42, 44 are mounted in the field to a concrete foundation 48.

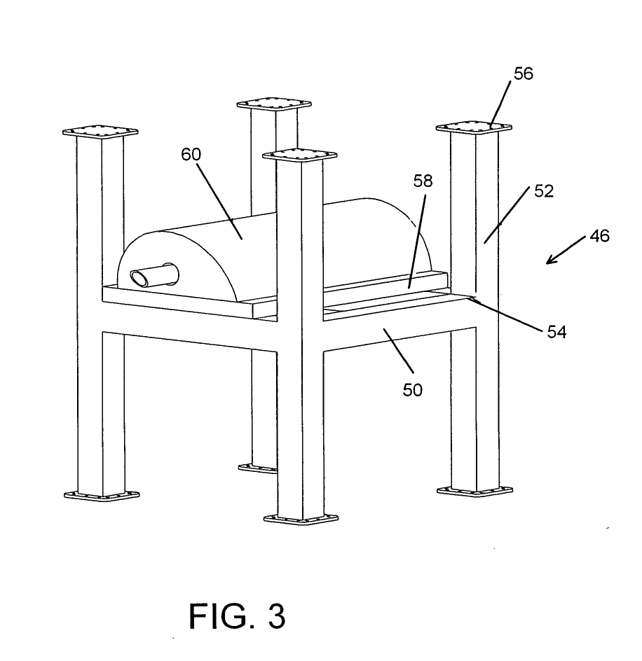

In the preferred embodiment, the tower is constructed of integral modules. Each module 46 is constructed of horizontal beams 50 and vertical beams 52 that are coupled together (i.e., by welding or other appropriate coupling means) at the joints 54 and capped by a plate flange 56 (see FIG. 3). Preferably, the beams 50, 52 can be about 4 inch square tubes that are comprised of steel. The beams 50, 52 can be filled with damping shot (not shown) such as sand, beads, and the like. Elastomeric mounts (not shown) are disposed on the horizontal beams 50 that will act as a mount for a shelf (or isolation slab or table top) 58 (shown in FIGS. 2, 3 and 5). The laser acoustic sensors (or combination laser transmitter and coherent optical receiver module or laser transmit receive head or sensor) 60 and/or a retro-reflector (or reflector or optical reflector) 62 can be mounted on the shelf 58. In alternative embodiment, the tower is separable, being constructed of several pieces.

The tower structure is designed to minimize the impact of modal vibration in the frequency range of interest while retaining a practical, cost effective structure. The damping features ensure that the structural-borne noise is minimal. Although steel is the preferred material, other materials are contemplated including ferrous metallic alloys, non-ferrous metallic alloys, concrete, fiber-based composites, and the like.

A preferred tower will have a static deflection limited to about 0.5 cm translation and about 50 micro-radians twist about the vertical axis. This will ensure that the transmit/receive sensor heads remain sufficiently aligned with the retro-reflectors. Additionally, the preferred tower will have a dynamic vibrations controlled modal design and structure damping in order to keep the structural noise limited in a frequency range of about 200 hertz (Hz) to about 400 Hz. The intent is to keep the vibrations minimal so as to not interfere with the sensing of the acoustic waves from remote hazardous conditions. Additionally, due to the height of the towers, the tower must be designed to withstand extreme weather conditions and wind loading.

Referring again to FIG. 2, the billboard array 40 comprises at least one tower 42 having at least one laser-acoustic sensor 60. Laser acoustic sensors 60 are disposed on three towers 42, 42a, 42b, while at least one tower 44 comprises at least one retro-reflector 62 aligned with the at least one laser acoustic sensor 60 of the other tower 42b. A beam of light 61 is projected from the laser acoustic sensor 60 to the retro-reflector 62. In a preferred embodiment, five laser acoustic sensors 60 are vertically stacked on the tower. The number of laser acoustic sensors 60 and retro-reflectors 62 utilized will be dependent upon the height of the tower and location of the area needing to be sensed, as can be defined by one skilled in the art.

The two center towers 42a and 42b can have both a laser acoustic sensor and a retro-reflector 63. For example, on each shelf 58 of tower 42a will be a combination laser acoustic sensor and retro-reflector 63 that can reflect the laser light from the parallel laser acoustic sensor 60 from tower 42 as well as transmitting its own laser light to tower 42b. The same configuration applies to each module 46 of tower 42b as well. In this case, the outer tower 42 has only a laser acoustic sensor 60 and the outer tower 44 has only a retro-reflector 62. Any numbers of configurations are contemplated; the preceding is merely illustrative of the concept.

An auxiliary laser acoustic sensor 64 can be mounted on a pedestal 66 on the ground and a retro-reflector 68 mounted on a pedestal 70 at the rear of the billboard array 40 to provide a measure of back lobe suppression. For this concept, back lobe suppression is achieved through sub-optimal adaptive beamforming. Adaptive beamforming is a technique to add the signals from the elements of an array in such a way that there is more sensitivity, or array gain, to signals that originate from specific regions. Numerical weights are added to the signals from a subset of elements in the billboard array in order to reduce the sensitivity noise coming from behind the array. Supplemental sensors added behind the main focused array augment this back lobe suppression. FIG. 2 illustrates a possible configuration using an additional sensor element, although any number of back lobe elements can be utilized, as well as utilizing an existing set of sensors disposed in the billboard array.

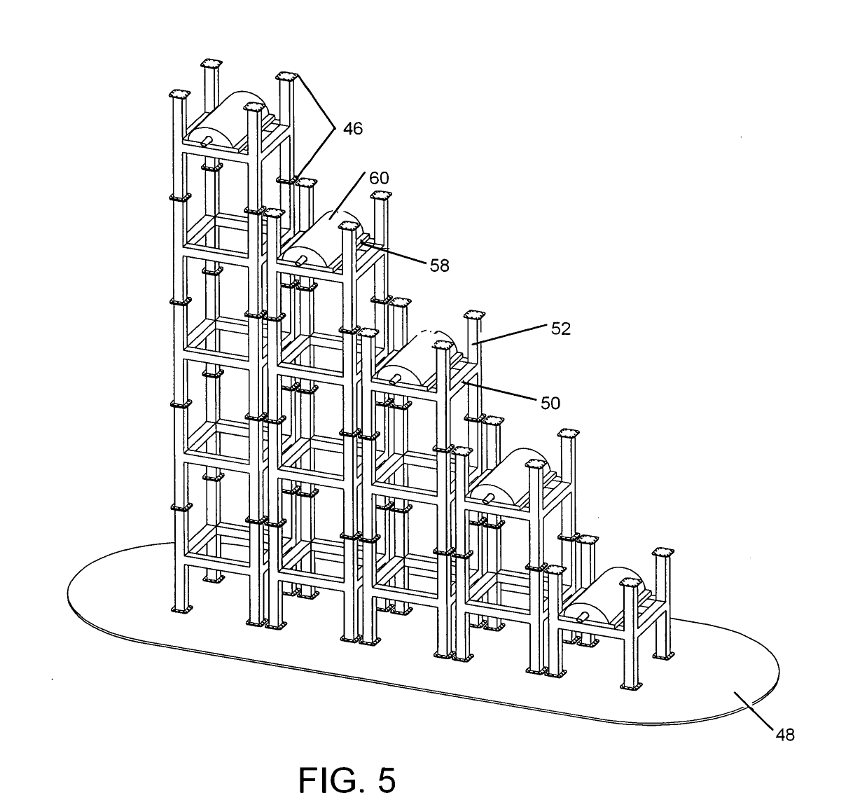

Referring now to FIG. 5, another configuration of the billboard array tower is illustrated. The individual tower 42 can be “stepped.” The angle λ of the tower can be any degree (i.e., 0° to 90°), which is configurable to support the requirements of the laser acoustic sensors and retro-reflectors, as well as providing a focused sensing area. For example, FIG. 2 illustrates a tower having an angle λ of 90°, or vertical, while FIG. 5 illustrates a tower having an angle λ of about 45°. In another embodiment, the opto-acoustic sensors and retro-reflectors may be disposed on the ground or horizontal (i.e., at an angle λ of 0°) creating the necessary configuration to operate the array.

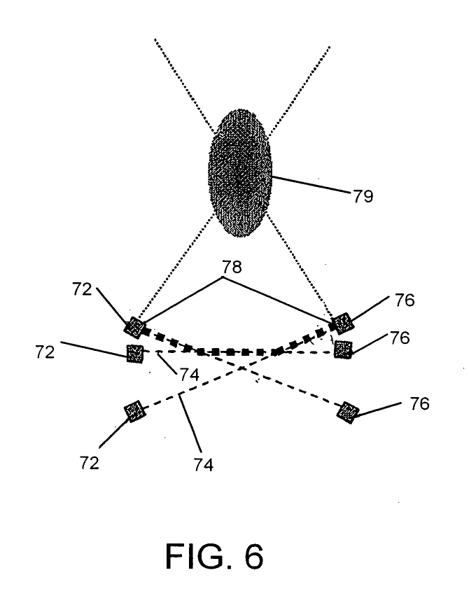

Referring now to FIG. 6, another configuration of focusing an opto-acoustic sensor array by overlapping laser beams is illustrated. FIG. 6 illustrates a top view of a opto-acoustic sensor array having a series of laser acoustic sensors 72 that each project a beam of laser light 74 to a mated pedestal mounted retro-reflector 76. The positioning of the laser acoustic sensors 72 and retro-reflectors 76 creates an overlapping of the beams 78 that produces a virtual focusing region 79. In this embodiment, only one laser acoustic sensor 72 (or a tower encompassing several laser acoustic sensors 72) can be utilized, as long as a mated retro-reflector 76 is utilized (either an individual or a tower of several).

As illustrated in FIG. 6, this focused array concept is roughly analogous to a camera lens that has a focal region dependant upon the wavelength of the disturbance and the aperture (or width) of the array. The length and width of the focal region can be approximated through the well-known Fresnel formula for lenses or computed through a numerical simulation. The focal region defines an area where sound can be resolved with an enhanced gain, magnifying the signal from sources in the focal region. This focused array concept can electronically steer the focal region (or window of interest) throughout space through the use of time-domain acoustic beamforming. Beamforming is a technique to add delays to the signals received by each element of the array before summation. In effect, this provides a type of triangulation of source sounds since each element will have a different relative time delay (or viewing angle) to the source. The volume of space is scanned to provide the delay or lag all points in space to each of the array elements. The beamformed signal will be strongest when the electronic scanning crosses the sound source, which allows atmospheric disturbances to be located and tracked. This focused array concept can locate sources in three-dimensions due to its focused layout of billboard arrays.

In operation, each laser acoustic sensor directs an optical beam to an accompanying reflector, as illustrated in FIGS. 2, 5, 6, 7, and 8. The reflector returns light to the laser acoustic sensor. As the light travels between the laser acoustic sensor and the reflector, a variation in the index of refraction will change the effective path length, and time, for the light to complete the circuit. As sound waves generated by some distant atmospheric disturbance arrive and cross the optical path, the index of refraction will vary so that the path length change in the optical path is a measure of the sound. This allows the laser acoustic sensor to behave as a sensitive microphone that can detect hazardous weather and wake vortex conditions at a standoff distance.

The opto-acoustic sensor array utilizes the plurality of laser acoustic sensors as a discrete lens system. By properly arranging the laser acoustic sensors and retro-reflectors, a geometric focal point (GFP) is created at a defined location. Sound sources can then be tracked within a certain volume around the GFP that depends upon the direction of the beam patterns from each of the opto-acoustic sensor arrays.

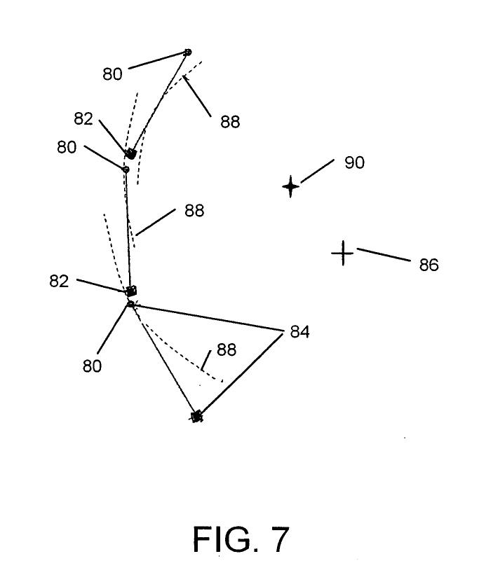

FIG. 7 is a top view of an opto-acoustic sensor array having an end-to-end design of laser acoustic sensors. In this embodiment, each laser acoustic sensor disposed on a tower 80 has an individual reflector disposed on a tower 82, creating an opto-acoustic sensor array segment 84. In FIG. 7, three opto-acoustic sensor array segments 84 are illustrated. FIG. 7 shows the focusing layout of the opto-acoustic sensor array. When a sound source is located at location 86 (i.e., the geometric focal point (GFP)), the acoustic waves 88 will reach the opto-acoustic sensor array segments 84 in phase, or in other words, at the same relative time. In contrast, if the sound source 90 is not located at the GFP 86, the phase (or time delay) between the acoustic waves 88 at each laser acoustic sensor is used to locate and track a sound source 90 by using the beamforming technique. The GFP indicates where the physical array is pointed. Electronic steering allows the array to listen to locations outside of the GFP in order to locate and track sources throughout the volume of interest.

Each laser acoustic sensor has an individual acoustic beam pattern. These beam patterns are characterized by a near-field behavior that has extreme directivity with up to about 20 dB to about 40 dB drop-off in sensitivity outside a swath that is roughly equivalent to the length of the sensor. The near-field, characterized by the Rayleigh distance is about 10,000 meters for about a 100 m beam. In the far-field, outside this Rayleigh distance, the sensor loses this directivity, but the concept of operations can be within this about 10,000 meter limit. The directivity of the arrays is important, because the laser acoustic sensor will pick out a wake vortex sound while ignoring interfering sound sources that may be generated by aircraft engines or ground operations at an airport.

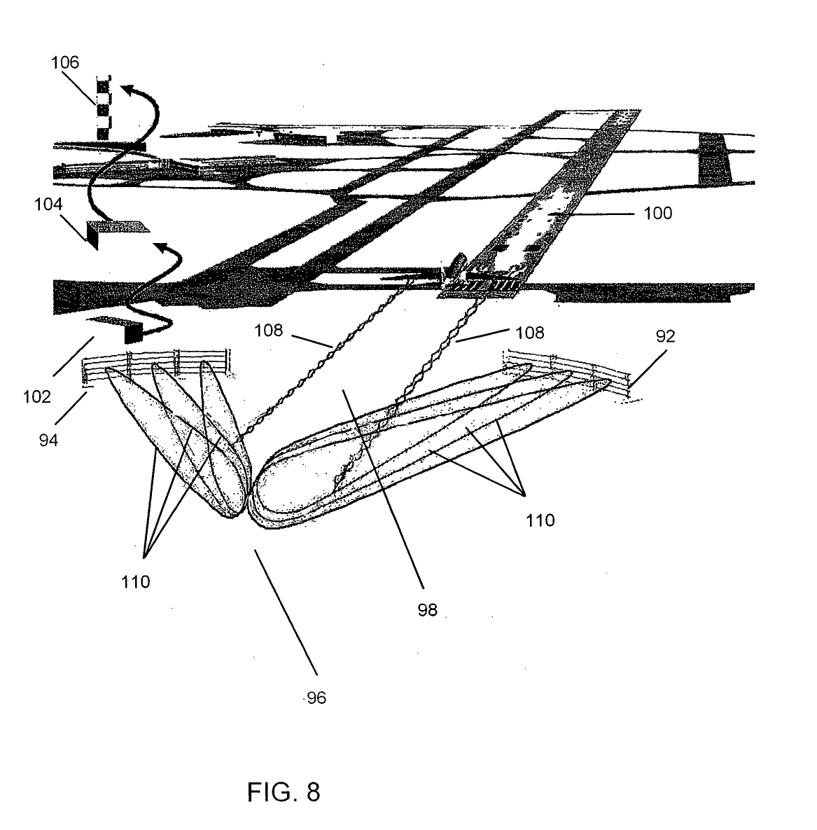

Referring now to FIG. 8, when determining the distance to the sound source, each beam pattern can be recorded and processed in an off-sensor facility. Alternatively, a small field unit 102 can be utilized to house the network hardware necessary to support the laser acoustic sensors on the airport grounds. The processing of the incoming sensor signals can be beamformed and processed in a small computer server located in some convenient airport building 104. A concept of operations (CONOPS) control center 106 for each airport provides a means to make the resulting wake vortex tracks useful to the airport traffic control.

By increasing the space between the stacked laser acoustic sensors, the overall aperture of the opto-acoustic sensor array increases and produces a narrower beam pattern. This gives the array a higher resolution (or more precise location) of the sound sources. The requirement for tracking resolution is set by the needs of the air traffic control CONOPS.

The ability to project a beam pattern of the opto-acoustic sensor array allows for the capturing of sound in a specific volume, as illustrated in FIG. 8. Two billboard type opto-acoustic sensor arrays 92, 94 are positioned to allow for the GFP to be at the geometric stabilized approach point (G-SAP) 96 along the approach corridor 98 of an airport runway 100. In this embodiment, the distance from the source of the sound (i.e., the wake vortex) 108 to the opto-acoustic sensor arrays 92, 94 can be about 200 meters to about 2000 meters, with about 1100 meters preferred. The sensing area of the two billboard type opto-acoustic sensor arrays 92, 94 is illustrated in FIG. 8 by numeral 110. By increasing the number of laser acoustic sensors and the resulting array gain produced, the threshold of detection is lower and detection ranges are greater than for prior art laser acoustic systems. By increasing the number of laser acoustic sensors and the number of billboards, gain is increased. Any number of laser acoustic sensors and billboard combinations are possible as described herein. The GFP can be moved by changing the relative angles of the billboard arcs, which increase the range of detection to be at a distance even farther.

The configuration of the opto-acoustic sensor array allows for a focusing gain in the volume of interest as well as a defocusing in the back field and a high degree of rejection of sound to the sides. Thus, the opto-acoustic sensor array is highly directional and can operate in a noisy environment, such as an airport. It focuses only on the region where the wake vortices are formed and are potentially hazardous to other aircraft.

The present invention provides an array that has the ability to focus and track sound at stand-off ranges. The stand-off range allows more flexibility in the location of the laser acoustic sensor on the ground at several different types of airports. The three-dimensional tracking allows for a broader use including CONOPS scenarios. The present invention is more robust and cost-efficient than other systems utilized to detect sound emanating from hazardous conditions, in particular, wake vortices. The present invention provides for easier alignment of each individual laser acoustic sensor in the field.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiment disclosed as the best mode contemplated for carrying out this invention.

What is claimed is:

1. A method of detecting hazardous conditions to aircraft, the hazardous conditions producing sound waves in the atmosphere, comprising:
directing a first laser beam from a first laser acoustic sensor to a mating first reflector, a second laser beam from a second laser acoustic sensor to a mating second reflector, and a third laser beam from a third laser acoustic sensor to a mating third reflector;
aligning said first laser acoustic sensor to project a first beam pattern towards a geometric focal point at a distance from said first laser acoustic sensor;
aligning said second laser acoustic sensor to project a second beam pattern towards said geometric focal point at said distance from said second laser acoustic sensor;
aligning said third laser acoustic sensor to project a third beam pattern towards said geometric focal point at said distance from said third laser acoustic sensor; and
measuring an effect of the sound waves on said first beam pattern, said second beam pattern, and said third beam pattern, said effect is an indicator of the hazardous conditions.

2. The method of claim 1, further comprising:
electronically steering said first beam pattern, said second beam pattern, and said third beam pattern.

3. The method of claim 1, further comprising:
disposing said first laser acoustic sensor on a first tower;
disposing said second laser acoustic sensor and said first reflector on a second tower;
disposing said third laser acoustic sensor and said second reflector on a third tower; and
disposing said third reflector on a fourth tower, wherein said first tower, said second tower, said third tower, and said fourth tower are configured as a billboard array.

4. The method of claim 3, wherein said billboard array is configured in an arc and said towers have an angle of about 0° to about 90° relative to a horizontal plane.

5. The method of claim 3, wherein said first reflector is disposed on said second laser acoustic sensor and said second reflector is disposed on said third laser acoustic sensor.

6. The method of claim 1, further comprising:
disposing said first laser acoustic sensor, said second laser acoustic sensor, said third laser acoustic sensor, said first reflector, said second reflector, and said third reflector on separate towers, said towers are configured as a billboard array.

7. The method of claim 6, wherein said billboard array is configured in an arc and said towers have an angle of about 0° to about 90° relative to a horizontal plane.

8. The method of claim 1, further comprising:
directing at least one other laser beam from at least one other laser acoustic sensor to at least one other mating reflector.

9. The method of claim 8, further comprising:
disposing said at least one other laser acoustic sensor on at least one other tower; and
disposing said at least one other mating reflector on at least another tower.

10. The method of claim 1, further comprising:
overlapping said first laser beam, said second laser beam and said third laser beam.

11. The method of claim 1, further comprising:
horizontally aligning said first laser beam, said second laser beam and said third laser beam to be parallel.

12. The method of claim 1, wherein said first reflector, said second reflector, and said third reflector are Eaton lenses.

13. An apparatus for detecting hazardous conditions to aircraft, the hazardous conditions producing sound waves in the atmosphere, comprising:
a first laser acoustic sensor configured to project a first laser beam to a mating first reflector, a second laser acoustic sensor configured to project a second laser beam to a mating second reflector, and a third laser acoustic sensor configured to project a third laser beam to a mating third reflector;
a first beam pattern aligned and projected from said first laser acoustic sensor towards a geometric focal point at a distance from said first laser acoustic sensor;
a second beam pattern aligned and projected from said second laser acoustic sensor towards said geometric focal point at said distance from said second laser acoustic sensor;
a third beam pattern aligned and projected from said third laser acoustic sensor towards said geometric focal point at said distance from said third laser acoustic sensor; and
a means for measuring an effect of the sound waves on said first beam pattern, said second beam pattern, and said third beam pattern, said effect is an indicator of the hazardous conditions.

14. The apparatus of claim 13, further comprising:
a means for electronically steering said first beam pattern, said second beam pattern, and said third beam pattern.

15. The apparatus of claim 13, further comprising:
a first tower comprising said first laser acoustic sensor;
a second tower comprising said second laser acoustic sensor and said first reflector;
a third tower comprising said third laser acoustic sensor and said second reflector; and
a fourth tower comprising said third reflector, wherein said first tower, said second tower, said third tower and said fourth tower are configured as a billboard array.

16. The apparatus of claim 15, wherein said billboard array is configured in an arc and said towers have an angle of about 0° to about 90° relative to a horizontal plane.

17. The apparatus of claim 15, wherein said first reflector is disposed on said second laser acoustic sensor and said second reflector is disposed on said third laser acoustic sensor.

18. The apparatus of claim 13, wherein said first laser acoustic sensor, said second laser acoustic sensor, said third laser acoustic sensor, said first reflector, said second reflector, and said third reflector are disposed on separate towers, wherein said towers are configured as a billboard array.

19. The apparatus of claim 18, wherein said billboard array is configured in an arc and said towers have an angle of about 0° to about 90° relative to a horizontal plane.

20. The apparatus of claim 13, further comprising:
at least one other laser acoustic sensor emitting at least one other laser beam to at least one other mating reflector.

21. The apparatus of claim 20, further comprising:
at least one other tower comprising said at least one other laser acoustic sensor; and
at least another tower comprising said at least one other mating reflector.

22. The apparatus of claim 13, wherein said first laser beam, said second laser beam and said third laser beam overlap.

23. The apparatus of claim 13, wherein said first laser beam, said second laser beam and said third laser beam are aligned parallel.

24. The apparatus of claim 13, wherein said first reflector, said second reflector, and said third reflector are Eaton lenses.
